(19) United States
(12) Patent Application Publication
(10) Pub. No.: US 2013/0247039 A1
(43) Pub. Date: Sep. 19, 2013

(54) COMPUTER SYSTEM, METHOD FOR ALLOCATING VOLUME TO VIRTUAL SERVER, AND COMPUTER-READABLE STORAGE MEDIUM

(71) Applicant: Yusuke Tsutsui, Fujisawa (JP)

(72) Inventor: Yusuke Tsutsui, Fujisawa (JP)

(21) Appl. No.: 13/825,708

(22) PCT Filed: Nov. 8, 2010
(86) PCT No.: PCT/JP2010/069861

§ 371 Date: May 31, 2013

(51) Int. Cl. G06F 9/455

(52) U.S. Cl. CPC G06F 9/455
USPC 718/1

(57) ABSTRACT

An embodiment of the invention is a computer system, including a management apparatus, a storage apparatus and a physical server. The management apparatus registers a master volume created from a first volume provided by the storage apparatus to a first virtual server in operation. The storage apparatus creates, when a second volume provided by the storage apparatus to a second virtual server operating on the physical server satisfies a specific similarity condition with respect to the registered master volume, a difference volume for storing difference data between the master volume and a volume of the second virtual server. The second virtual server accesses the difference volume and the master volume.

### BACKGROUND

The present invention relates to a computer system, a method of allocating a volume to a virtual server, and a computer-readable storage medium, and particularly, to allocation of a volume to a virtual server in a storage apparatus.

In recent years, information system departments in companies are increasingly demanded to reduce investment costs and operational costs on information technology. In order to cope with such a demand, a system virtualization technology is utilized as a technology to effectively use computer resources such as a CPU, a memory device, and a storage device.

The system virtualization technology can create a plurality of virtual computers on a single physical computer so that the single physical computer can execute processing as if it were a plurality of computers. This technology is used for the purpose of effectively using excess computer resources and for the purpose of server consolidation for aggregating several hundred guests on a single high-performance computer.

A virtual computer is a server environment which is realized by software, and an operating system (OS) operates on the virtual computer to run an application. In the virtual environment, a virtual server in which some pieces of middleware are installed and various settings are made after installation of the OS may be created as a template, and the template data may be copied to create a virtual server. The OS portion of the virtual server is not modified frequently in normal operation, and hence a vast amount of redundant data is present in the storage device.

A technology of deleting redundant data in a storage device is disclosed in, for example, Patent Literature 1. Patent Literature 1 discloses a storage controller that compares Hash values of data to delete redundant data.
Patent Literature 1: Japanese Patent Application Laid-open No. 2009-251725

### SUMMARY

Reducing the actual size (amount of data stored) of a storage device is important in a built system. Specifically, in a computer system having a plurality of virtual servers in operation, it is demanded to reduce the actual size of volumes allocated to the virtual servers in operation. In making transition of a physical environment in operation to a virtual environment, it is demanded to effectively reduce the size of the volume of a virtual server to be newly mounted.

As apparent from the above, it is important that reduction in the actual size in storage in an existing system can cope with a change in system. In reduction of the actual usage amount in storage in a virtual environment in operation, it is important to quickly and effectively reduce the large size of the volume of a virtual server that is desired to be reduced in size.

An aspect of the invention is a computer system, including a management apparatus, a storage apparatus and a physical server. The management apparatus registers a master volume created from a first volume provided by the storage apparatus to a first virtual server in operation. The storage apparatus creates, when a second volume provided by the storage apparatus to a second virtual server operating on the physical server satisfies a specific similarity condition with respect to the registered master volume, a difference volume for storing difference data between the master volume and a volume of the second virtual server. The second virtual server accesses the difference volume and the master volume.

According to an aspect of the invention, it is possible to effectively reduce the actual size of a storage device in a built virtual environment.

### BRIEF DESCRIPTION OF THE DRAWINGS

FIG. 1A is a diagram illustrating the outline of this embodiment.

FIG. 1B is a diagram illustrating the outline of this embodiment.

FIG. 2A is a diagram schematically illustrating the general configuration of a computer system according to this embodiment.

FIG. 2B is a diagram schematically illustrating the general configuration of the computer system according to this embodiment.

FIG. 3 is a diagram schematically illustrating the configuration of a management server according to this embodiment.

FIG. 4 is a diagram schematically illustrating the configuration of a physical server according to this embodiment.

FIG. 5A is a diagram schematically illustrating the configuration of the physical server according to this embodiment.

FIG. 5B is a diagram schematically illustrating the configuration of the physical server according to this embodiment.

FIG. 6 is a diagram schematically illustrating the configuration of the physical server according to this embodiment.

FIG. 7 is a diagram illustrating an address conversion method in accessing a virtual disk according to this embodiment.

FIG. 8 is a diagram illustrating an example of a mapping table used in address conversion in accessing a virtual disk according to this embodiment.

FIG. 9 is a flowchart illustrating the flow of a routine including registration of a master disk according to this embodiment.

FIG. 10 is a diagram illustrating an example of a virtual image management table according to this embodiment.

FIG. 11 is a diagram illustrating an example of a virtual server management table according to this embodiment.

FIG. 12 is a flowchart illustrating the flow of a disk image analysis routine according to this embodiment.

FIG. 13 is a flowchart illustrating the flow of a master disk determination routine according to this embodiment.

FIG. 14 is a flowchart illustrating the flow of a difference disk creating routine according to this embodiment.

FIG. 15 is a flowchart illustrating the flow of transition from a physical environment to a virtual environment according to this embodiment.

FIG. 16 is a flowchart illustrating the flow of transition from a physical environment to a virtual environment according to this embodiment.

### DETAILED DESCRIPTION OF EMBODIMENTS

Embodiments according to this invention are described below referring to the accompanying drawings. In order to clarify the description, in the following description and the drawings, some omissions and simplification are made as needed. Further, the same reference numerals are given to the same elements throughout the drawings to avoid redundant descriptions as needed for clarification of the description.

<Outline of the Embodiment>

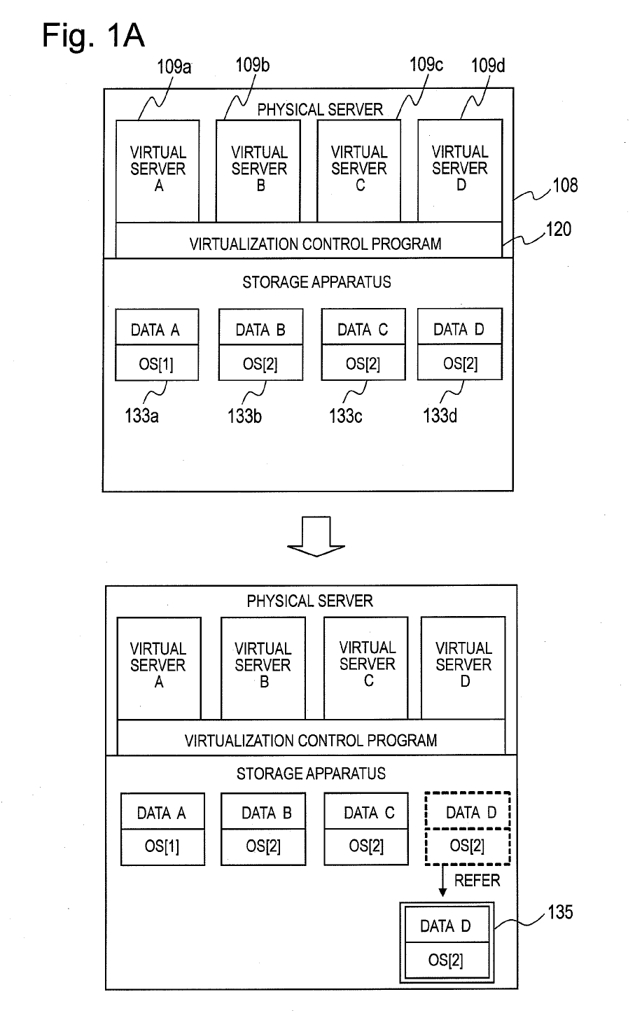

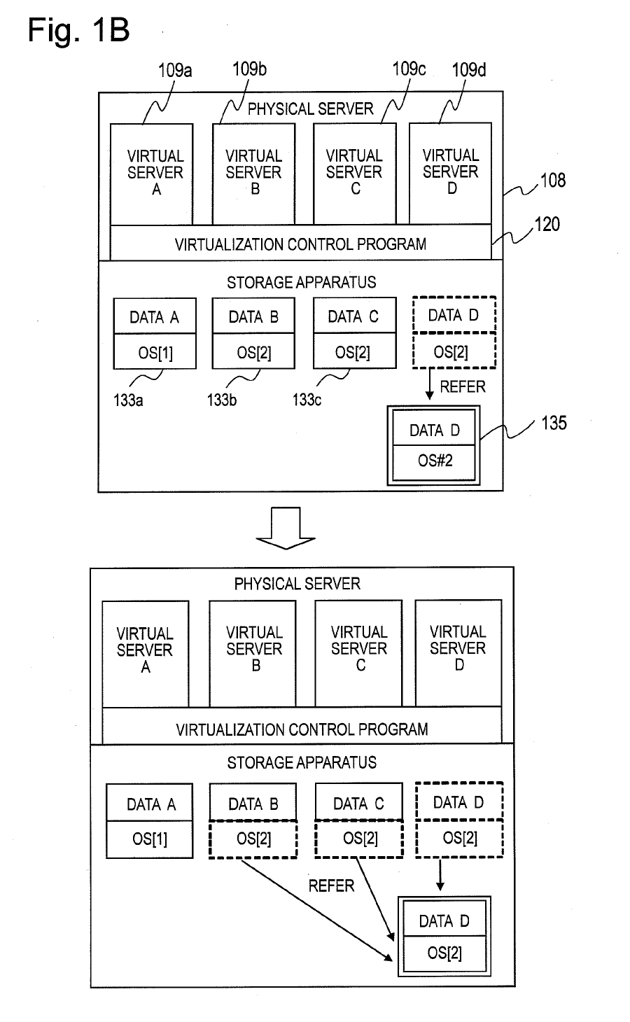

FIGS. 1A and 1B are diagrams illustrating the outline of this embodiment. Roughly, this embodiment executes two processes. In the first process, a master volume is created from a volume of a virtual server in operation, and is registered in a list. In the second process, when the volume of another virtual server is similar to the master volume, a difference volume is created from those volumes.

This virtual server accesses the master volume and the difference volume. The virtual server is software, and a program including an operating system (OS) and other program modules. A volume is a data storage region defined in a storage device, and data in the data storage region, and is a logical volume. The master volume may be created by copying a volume of the virtual server, or the volume of the virtual server may be used directly as the master volume.

The region of that portion of the volume of another virtual server which is common to the master volume becomes a blank region (data deleted). Accordingly, the amount of data stored in the storage device (actual size) can be reduced. Because the entire volume of the virtual server is compared with the master volume, and the common portion is shared, the redundant portions in the volume can be reduced collectively and efficiently, and thus quick reduction of a large size from the beginning of the size reducing routine can be achieved.

In this configuration, a master volume is created from the volume of a virtual server in operation. Therefore, the volume size of the virtual server in a built system can be reduced appropriately, and the volume size of a virtual server to be newly mounted can be reduced in transition from a physical environment to a virtual environment.

FIG. 1A schematically illustrates the above-mentioned first process. In FIG. 1A, a virtualization control program 120 operates on a physical server 108, and virtual servers 109a to 109d operate on the virtualization control program 120. Volumes 133a to 133d are allocated to the virtual servers 109a to 109d respectively.

In FIG. 1A, the system selects the volume 133d of the virtual server 109d as a master volume 135. The volume is referred to in accessing of the volume 133d by the virtual server 109d. Subsequently updated data in the volume 133d is stored in a difference volume of the virtual server 109d.

FIG. 1B schematically illustrates the above-mentioned second process. In FIG. 1B, the OS in the volumes 133b and 133c is the same as the OS in the master volume 135. The system refers to the master volume 135 to generate a difference volume from the volumes 133b and 133c. Access to those portions in the volumes 133b and 133c which are common to the master volume 135 is carried out by referring to the master volume 135. In FIG. 1B, the image (data) of the OS[2] is made common.

A typical storage device includes a plurality of disk devices. Therefore, a volume which a virtual server accesses is called “disk”. This embodiment can also be adapted to a system which includes a storage device having a data storage device (storage medium) different from a disk device.

<General Configuration>

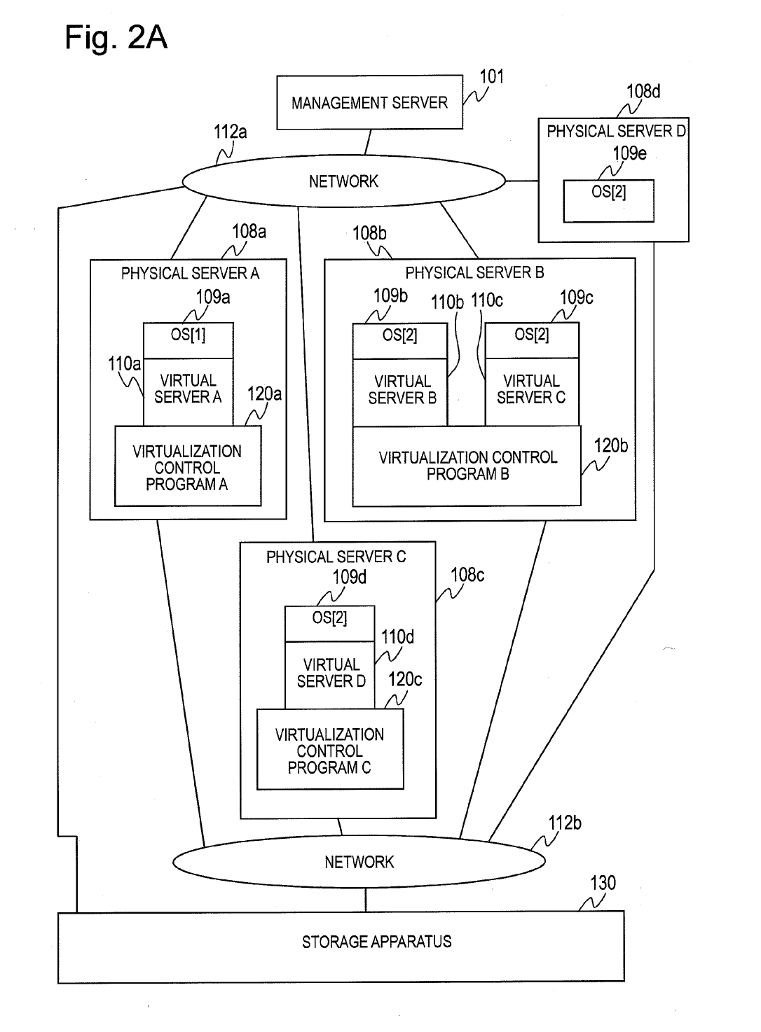

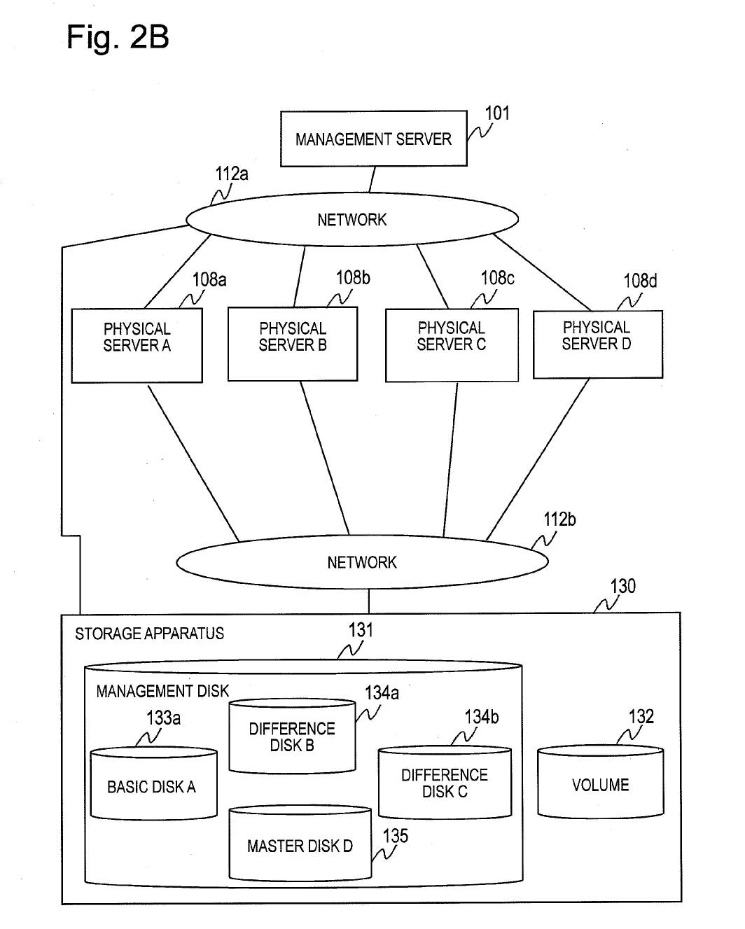

Next, the general configuration of a computer system according to this embodiment is described. FIGS. 2A and 2B schematically illustrate the general configuration of the computer system according to this embodiment. As illustrated in FIG. 2A, the computer system according to this embodiment includes a management server 101 which is a management apparatus, a plurality of physical servers 108a to 108d, and a storage apparatus 130. The management server 101 and the physical servers 108a to 108d are computer devices each including a program to be executed and data to be processed.

The plurality of physical servers 108a to 108d and the storage apparatus 130 are coupled by a data network 112b. The management server 101, the physical servers 108a to 108d, and the storage apparatus 130 are coupled by a management network 112a.

The data network 112b is a network for communication of data to be stored in the storage apparatus 130, and is typically a storage area network (SAN). The data network 112b may be a network other than a SAN as long as the network is for data communication, for example, an IP network may be used.

The management network 112a is a network for communication of management data, and is typically an IP network. The management network 112a may be a network other than an IP network as long as the network is for data communication, for example, an a SAN may be used. The data network 112b and the management network 112a may be the same network.

The management server 101 is a computer device for managing the physical servers 108a to 108d. In this embodiment, particularly, the management server 101 manages a process of creating a master disk for the physical servers 108a to 108d and difference disks therefor. The details of the process are described later. The physical servers 108a to 108c are computer devices capable of executing at least one virtual server using the virtualization technology. On the other hand, a virtualization mechanism (virtualization control program) is not mounted in the physical server 108d. An OS[2] 109e is installed in the physical server 108d. In OS[k], k indicates the type of the OS, and OS's with the same value for k are OS's of the same type.

The physical server 108a executes a virtualization control program A 120a, and a virtual server A 110a including an OS[1] 109a operates on the virtualization control program A 120a. The physical server 108b executes a virtualization control program B 120b, and a virtual server B 110b including an OS[2] 109b and a virtual server C 110c including an OS[2] 109c operate on the virtualization control program B 120b.

The physical server 108c executes a virtualization control program C 120c, and a virtual server D 110d including an OS[2] 109d operates on the virtualization control program C 120c. The physical servers 108a to 108c execute a process of creating a master disk and a difference disk in response to an instruction from the management server 101. The physical server 108d contributes to the creation of a difference disk in the transition from a physical environment to a virtual environment. The details are to be given later.

As illustrated in FIG. 2B, the storage apparatus 130 provides the physical servers 108a to 108d with volumes. In FIG. 2B, a volume 132 is a volume allocated to the physical server D 108d. A management disk 131 is a data storage region allocated to the physical servers A 108a to C 108c. FIG. 2B illustrate volumes 133a, 134a, 134b, and 135.

A basic disk A 133a is a disk (volume) allocated to the virtual server A. A difference disk B 134a and a difference disk C 134b are difference disks of the virtual server B 110b and the virtual server C 110c, respectively. A master disk D 135 is a master disk created from the basic disk allocated to the virtual server D.

The master disk D 135 is a master disk for the difference disks 134a and 134b. Unlike the master disk and difference disk, the basic disk is a normal volume which is initially allocated to a virtual server. The master disk and difference disk are created from the basic disk.

<Configuration of Management Server 101>

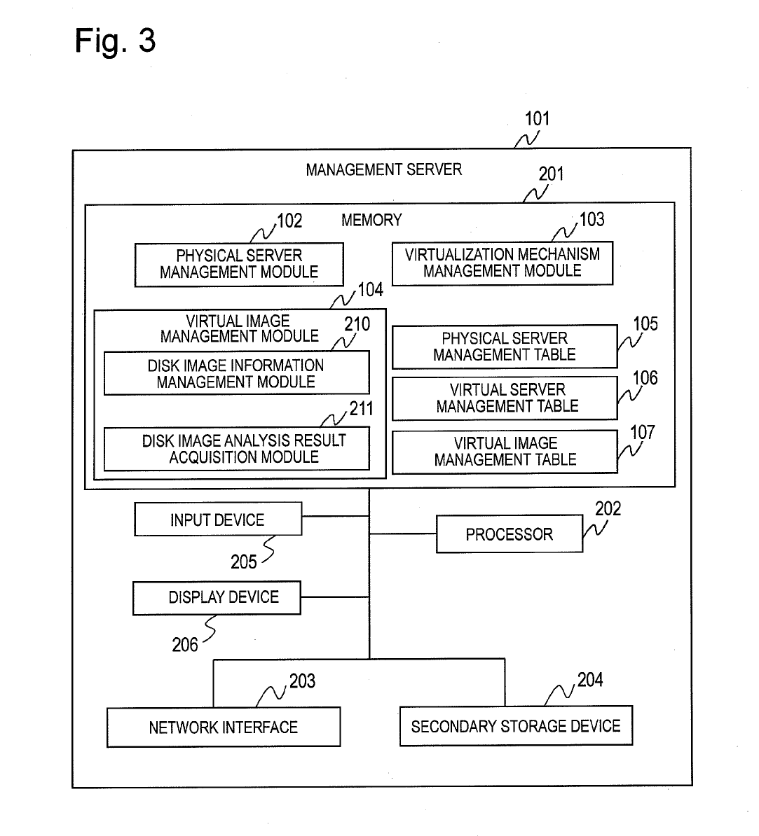

As illustrated in FIG. 3, the management server 101 is a computer device, and includes a memory 201, a processor 202, a network interface 203, a secondary storage device 204, an input device 205, and a display device 206. The individual devices in the management server 101 are connected by buses. The management server 101 is coupled to a management network 112a via the network interface 203.

An administrator of the computer system according to this embodiment can view management information of the system on the display device 206. The administrator can input data including commands to the management server 101 using the input device 205. It should be noted that the administrator may access the management server 101 over a network to use the functions of the management server 101.

The processor 202 realizes a predetermined function of the management server 101 by executing a program stored in the memory 201. The memory 201 is a storage device such as random access memory (RAM) that stores a program which is executed by the processor 202, and data needed for execution of the program.

The secondary storage device 204 is a storage device including a non-volatile storage medium that stores a program needed to realize a predetermined function of the management server 101 (for example, program stored in the memory 201 in FIG. 3) and data. Typically, the secondary storage device 204 is a hard disk drive. As the secondary storage device for data which is used by the management server 101, a non-volatile semiconductor memory device such as a flash memory may be used, or an external storage device (for example, storage apparatus 130) which is coupled over a storage area network (SAN) or the like may be used.

FIG. 3 illustrates programs and tables in the memory 201 for the sake of convenience. Data (including a program) which is needed in the processing of the management server 101 is typically loaded into the memory 201 from the secondary storage device 204. A physical server management module 102, a virtualization mechanism management module 103, and a virtual image management module 104 are programs. The processor operates based on those programs to function as the physical server management module 102, the virtualization mechanism management module 103, and the virtual image management module 104. The virtual image management module 104 includes a disk image information management module 210 and a disk image analysis result acquisition module 211. The details of the processes of those programs are to be given later.

A program is executed by the processor to carry out a specified process using the storage device and the communication interface. Therefore, a description mentioning a program as a subject according to this embodiment may be a description mentioning the processor as a subject. A process which is executed by a program is a process which is executed by a computer on which the program runs. This is true of physical servers to be described below.

The management server 101 further includes a plurality of tables. Specifically, the management server 101 includes a physical server management table 105, a virtual server management table 106, and a virtual image management table 107. The physical server management table 105 stores management information on physical servers, for example, the identifier of each physical server and the address thereof on a network.

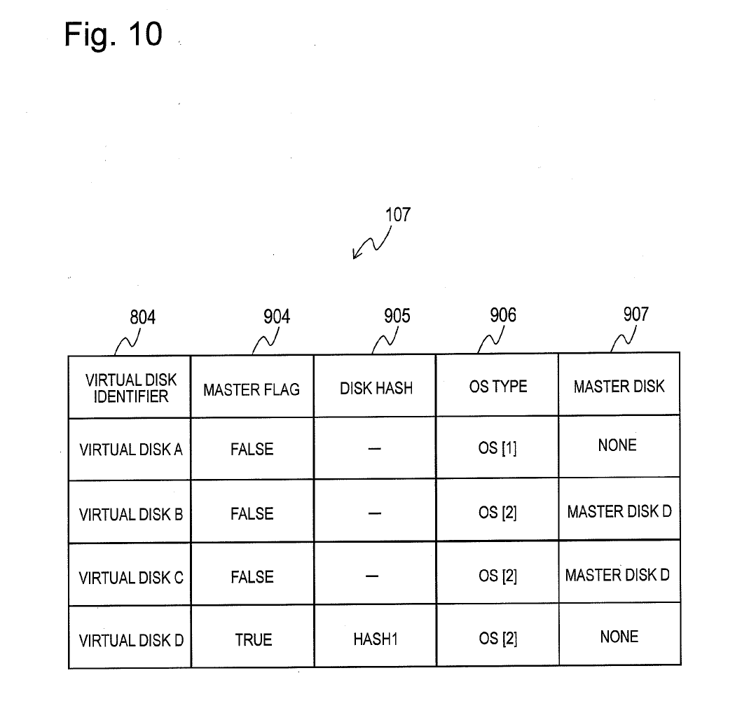

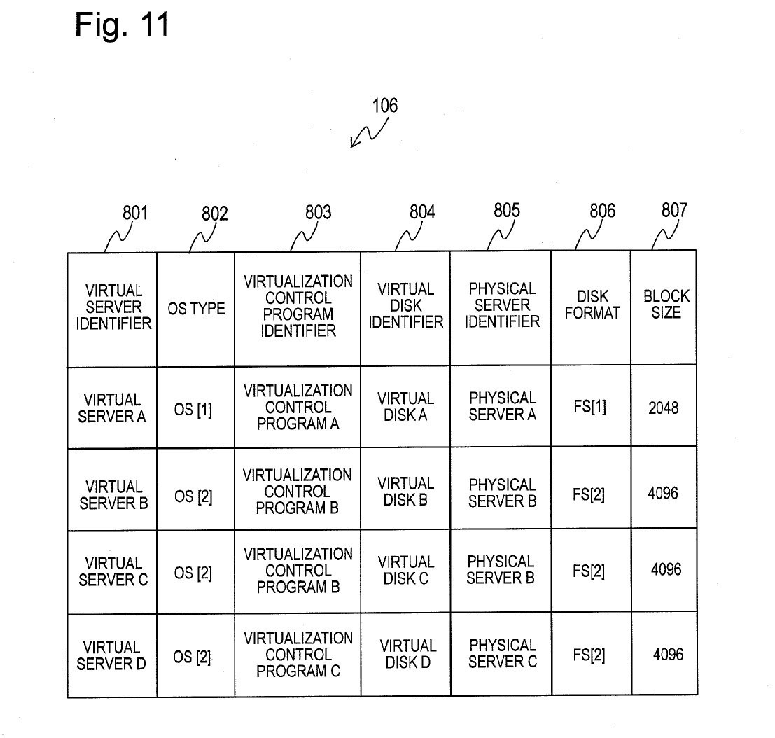

The virtual server management table 106 stores management information on virtual servers, and the virtual image management table 107 stores management information on virtual disks. Examples of the virtual server management table 106 and the virtual image management table 107 are illustrated in FIGS. 10 and 11, and details thereof are to be given later.

In this structural example, information which is used in the system operation management of the management server 101 is stored in each table. In this embodiment, however, information to be stored in the data storage region does not depend on the data structure, and may be expressed by any data structure. For example, information in the plurality of tables may be stored in a single table, or may be stored in a greater number of tables. The tables may have any structure (columns and records) as long as necessary information is stored therein. This is true of physical servers to be described below.

<Configuration of Physical Server D 108d>

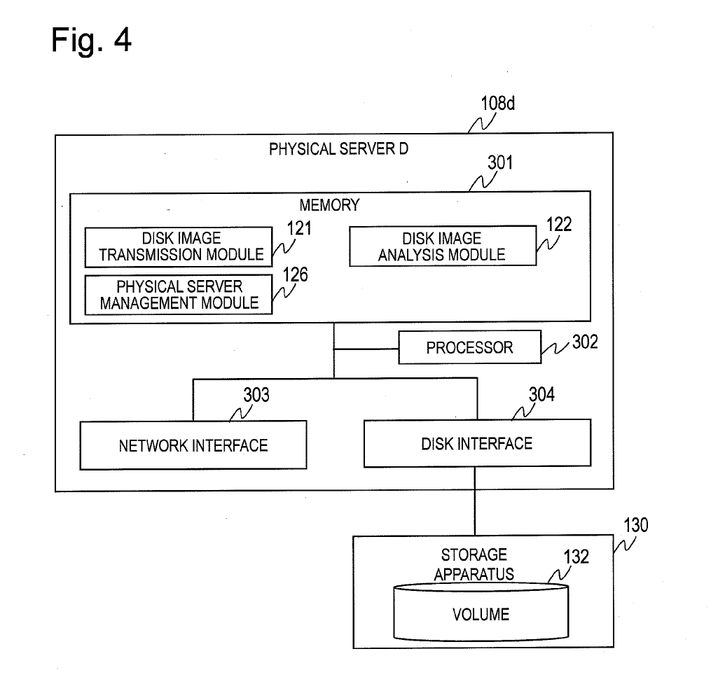

FIG. 4 is a diagram schematically illustrating the configuration of the physical server D 108d. As illustrated in FIG. 4, the physical server D 108d is a computer device including a memory 301, a processor 302, a network interface 303, and a disk interface 304. The individual components are connected in a communicable manner by buses. The physical server D 108d is coupled to the management network 112a via the network interface 303, and is coupled to the data network 112b via the disk interface 304.

The processor 302 accesses the volume 132 of the storage apparatus 130 via the disk interface 304 and the data network 112b. The processor 302 realizes a predetermined function of the physical server D 108d by executing a program stored in the memory 301.

The memory 301 stores a program including an OS which is executed by the processor 302, and data needed for execution of the program. FIG. 4 illustrates a disk image transmission module 121, a disk image analysis module 122, and a physical server management module 126 out of programs stored in the memory 301. The processes of those programs are described later. Those programs are typically loaded from a secondary storage device (not shown) of the physical server D 108d or a non-volatile storage medium (not shown) of the storage apparatus 130.

<Configuration of Physical Server B 108b>

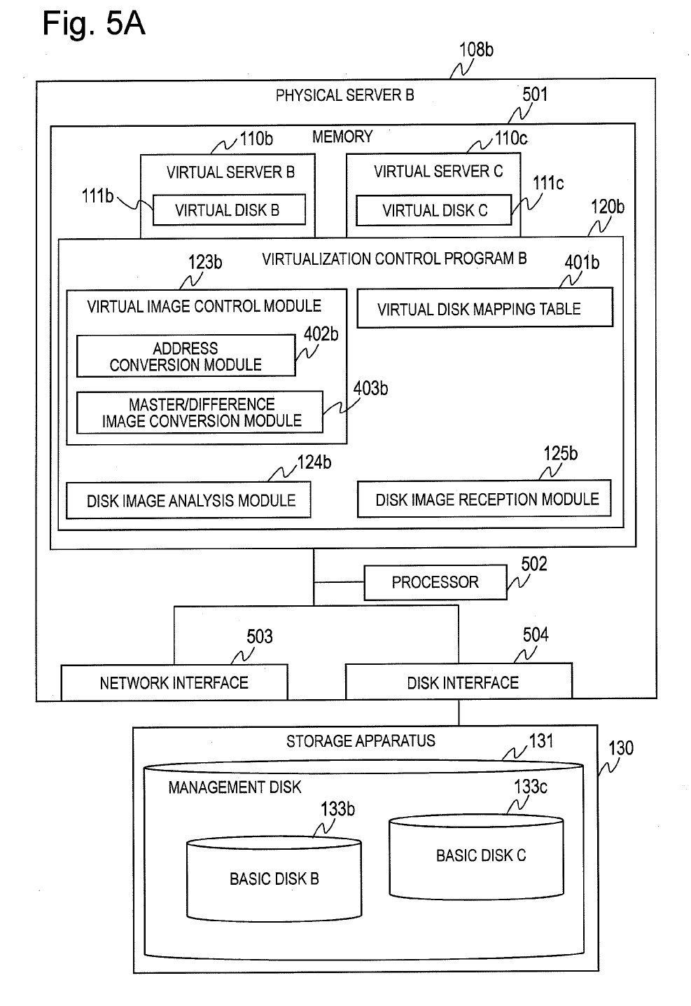

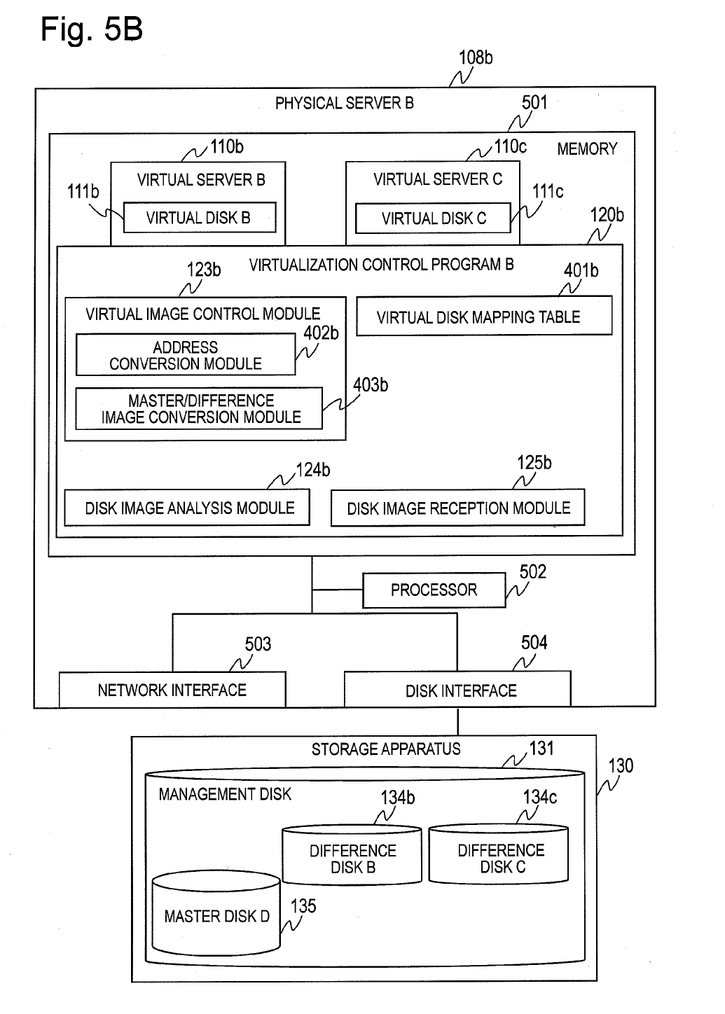

FIG. 5A is a diagram schematically illustrating the configuration of the physical server B 108b. The physical server B 108b is a computer device whose hardware configuration is substantially the same as those of the management server 101 and the physical server D 108d. Specifically, the physical server B 108b is a computer device including a memory 501, a processor 502, a network interface 503, and a disk interface 504. The individual components are connected in a communicable manner by buses.

The physical server B 108b is coupled to the management network 112a via the network interface 503, and is coupled to the data network 112b via the disk interface 504.

In the physical server B 108b, the virtual servers 110b and 110c operate on the virtualization control program 120b. The virtualization control program 120b is a program for logically dividing physical resources such as the memory 501 and the processor 502 included in the physical server B 108b, and allocating the physical resources to virtual servers so that the physical server B 108b executes at least one virtual server.

The virtual servers 110b and 110c are both programs which are executed by the virtualization control program 120b. The virtual servers 110b and 110c are executed by the virtualization control program 120b to behave as if they were a single computer device.

The virtual servers 110b and 110c include programs such as an OS and an application program, control data, user data, and the like. In the configuration example illustrated in FIG. 2A, the virtual servers 110b and 110c respectively include the OS[2] 109b and OS[2] 109c. Those OS's are of the same type. It should be noted that the programs and data included in the virtual servers 110b and 110c depend on the system configuration.

As illustrated in FIG. 5A, the virtualization control program 120b includes a plurality of program modules. Specifically, the virtualization control program 120b includes a virtual image control module 123b, a disk image analysis module 124b, and a disk image reception module 125b. The virtual image control module 123b includes an address conversion module 402b and a master/difference image conversion module 403b. The virtualization control program 120b further includes a virtual disk mapping table 401b. The virtual disk mapping table 401 and the processes of the individual programs of the virtual servers are described later.

In FIG. 5A, the storage apparatus 130 stores the basic disk B 133b and the basic disk C 133c. Those basic disks are initial volumes respectively allocated to the virtual server B 110b and the virtual server C 110c. A virtual disk B 111b and a virtual disk C 111c define the address spaces which the virtual server B 110b and the virtual server C 110c access. The address is an address (logical address) given to the storage apparatus 130.

The address of the virtual disk B 111b is associated with the address of the basic disk B 133b (address to be given to the storage), and the virtual server B 110b access only the basic disk B 133b. Likewise, the address of the virtual disk C 111c is associated with the address of the basic disk C 133c (address to be given to the storage), and the virtual server C 110c access only the basic disk C 133c.

As illustrated in FIG. 5B, according to this embodiment, those basic disks 133b and 133c are compared with the master disk to create difference disks. In FIG. 5B, the storage apparatus 130 stores the master disk D 135. The master disk D 135 is created from the basic disk of the virtual server D.

This computer system compares the basic disks 133b and 133c with the master disk D 135 to create a difference disk B 134b and a difference disk C 134c, respectively. The virtual servers 110b and 110c can access the master disk D 135, and the difference disk B 134b and the difference disk C 134c based on the same addresses for accessing the basic disks 133b and 133c.

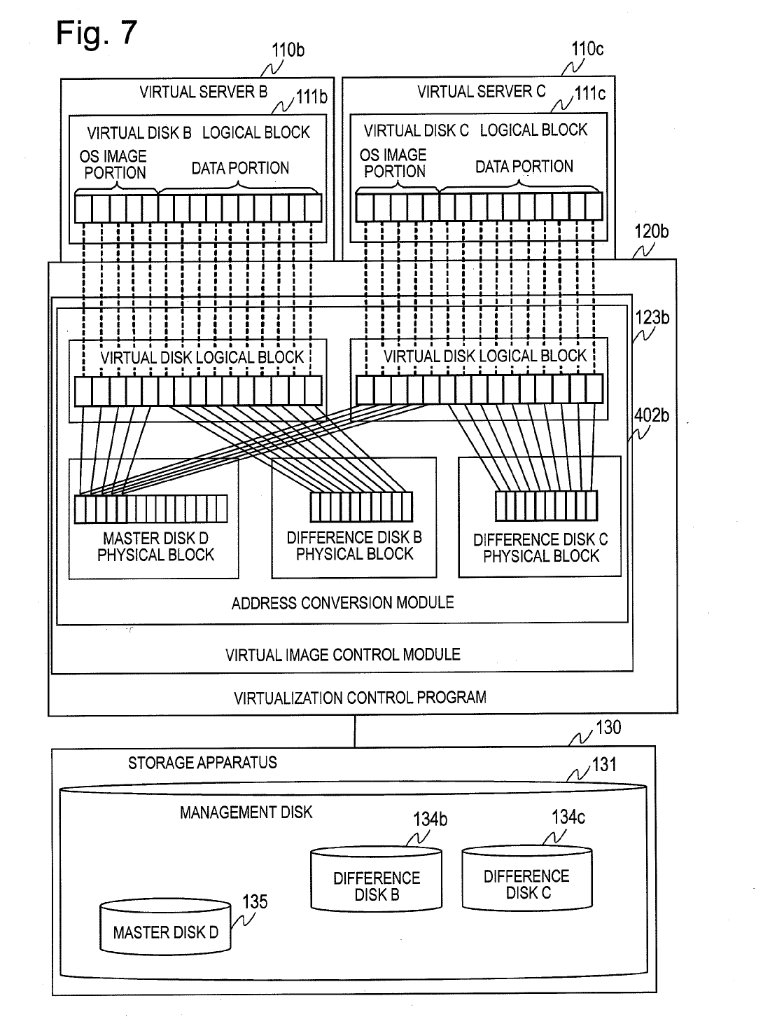

In other words, (the addresses of) the virtual disk B 111b and the virtual disk C 111c are associated with (the addresses of) the master disk 135 and the difference disk B 134b, and (the addresses of) the master disk 135 and the difference disk C 134c, respectively. The virtual servers 110b and 110c can access the master disk 135, and the difference disk B 134b and the difference disk C 134c by accessing (the addresses of) the virtual disk B 111b and the virtual disk C 111c, respectively. This address conversion is executed by the virtualization control program 120b. This is to be described later referring to FIG. 7.

<Configuration of Physical Server C 108c>

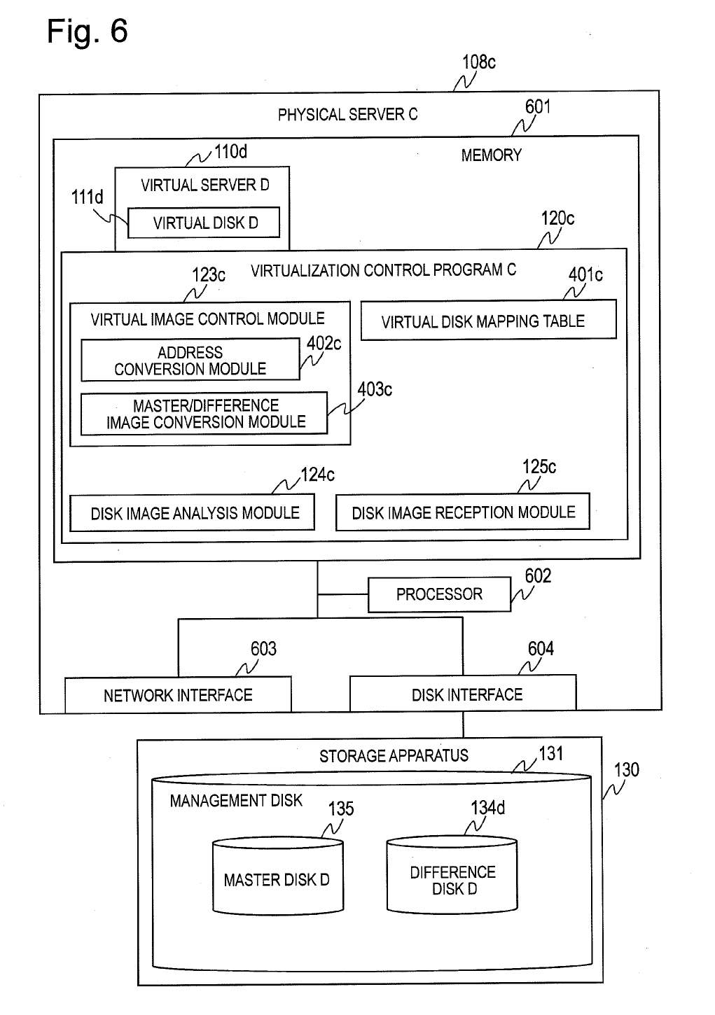

FIG. 6 schematically illustrates the configuration of the physical server C 108c. The physical server C 108c includes a memory 601, a processor 602, a network interface 603, and a disk interface 604. Because the hardware and software configurations of the physical server C 108c are substantially the same as those of the physical server B 108b illustrated in FIG. 5A, redundant descriptions thereof are omitted. In the physical server C 108c, the virtual server D 110d operates on the virtualization control program 120c. Because the functions (modules) of the virtualization control program 120c are the same as those of the virtualization control program 120b, redundant descriptions thereof are omitted.

The storage apparatus 130 stores the master disk D 135 and a difference disk D 134d. It is preferred that, when a master disk is created from a virtual disk (basic disk) in operation, the computer system create a difference disk for the virtual disk, and then the virtual server record the changed portion in its difference disk.

The master disk is the volume whose alteration is prohibited, so that the content is maintained. This computer system may create a copy disk of the basic disk, may use the copy disk as the master disk, and may keep using the basic disk. However, an increase in the actual disk usage amount caused by the creation of the master disk can be suppressed by creating the master disk from the basic disk, and further creating its difference disk.

Further, the creation of the master disk may be achieved by producing a copy of the basic disk, and then using the copy as the master disk. However, the use of the basic disk as the master disk as it is can increase the efficiency of the processing. In the example of FIG. 6, the computer system defines the basic disk D of the virtual disk D as the master disk D 135, and further creates the difference disk D 134d. The virtual server D 110d accesses the master disk D 135 and the difference disk D 134d, and the difference disk 134d stores changed data.

From the viewpoint of efficient processing, it is preferred that this computer system create, from a basic disk in operation, a master disk with the same configuration as that of the basic disk. Specifically, the basic disk itself is registered as the master disk, or the basic disk is copied to create a disk with the same contents.

The difference disk of the virtual disk stores data newly written after creation of the master disk. Depending on the design, the master disk may be created from only part of the basic disk. It should be noted that the physical server 108a has substantially the same configuration as those of the physical servers 108b, 108c, and description thereof is thus omitted.

<Virtual Disk Address Mapping>

FIG. 7 is a diagram illustrating virtual disk mapping in accessing (an image formed by) data stored in the master disk D 135 and the difference disk 134b, 134c. The entire logical block of the virtual disk B 111b includes a logical block of an OS image portion and a logical block of a data portion. Likewise, the entire logical block 111c of the virtual disk C includes a logical block of an OS image portion and a logical block of a data portion.

The virtual servers 110b, 110c access the storage apparatus 130 at the addresses of the logical blocks of the virtual disk B 111b and the virtual disk C 111c, respectively. The logical block is the access unit of the virtual server 110b, 110c, and is the minimum size of accessible data.

The OS image portion is a portion common to the master disk 135, which stores the same data as that the OS image portion has. The OS image portion can include a program and data besides the OS. The data portion is a logical block storing data other than the one in the OS image portion, and is not a portion common to the master disk 135. The data portion typically includes user data, and may include a program in addition thereto.

In access from the virtual server 110b, 110c, an address conversion module 402b of the virtualization control program 120b performs address conversion. The address conversion module 402b uses a virtual disk mapping table 401b. The address conversion module 402b receives the address of an access destination (the address of the logical block in the virtual disk B, C) from the virtual server 110b, 110c, and converts the address to the address of the master disk D 135 or the difference disk 134b, 134c (address of a physical block) in the storage apparatus 130.

Specifically, the address of the logical block in each of the virtual disk B and the virtual disks C 111b, 111c does not change before and after creation of the difference disk 134b, 134c. The virtual server 110b, 110c uses the same address as that used to access the basic disk 133b, 133c.

The address conversion module 402b acquires the address of the logical block in the virtual disk B 111b, C 111c from the virtual server 110b, 110c. The address conversion module 402b converts the acquired address to the address of the physical block of the master disk D 135 or the difference disk 134b, 134c by referring to the virtual disk mapping table 401b. The physical block is a block in the storage device, and the address of the physical block is a logical address to be transmitted to the storage apparatus 130.

This computer system may create a difference disk in a region completely different from the basic disk in the storage apparatus 130 and may use the physical storage region of the basic disk. In this configuration, the address of the physical block in the difference disk 134b, 134c is the same as the corresponding physical block address of the same logical block in the basic disk 133b, 133c. In the basic disk 133b, 133c, data in a physical block, which does not match with data in the master disk D 135, is stored in the difference disk 134b, 134c at the same physical block address.

The computer system may add a portion in the basic disk which becomes an empty region by the use of the master disk in its difference disk in association with a new logical block address, or may assign the portion to another virtual server.

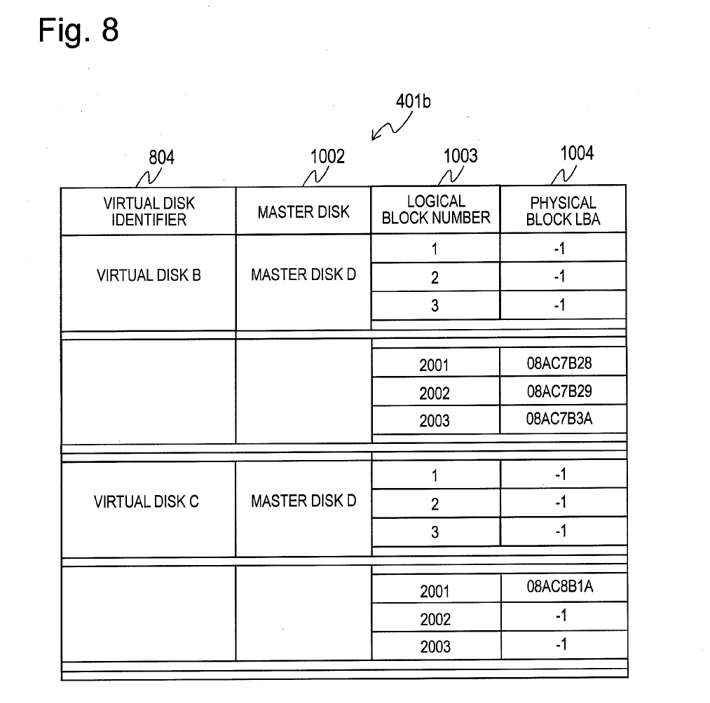

FIG. 8 illustrates an example of the virtual disk mapping table 401b. The virtual disk mapping table 401b includes a column 804 of virtual disk identifiers, a column 1002 of master disks, a column 1003 of logical block numbers, and a column 1004 of logical addresses of physical blocks (Logical Block Address: LBA).

FIG. 8 illustrates mapping data of the virtual disk B of the virtual server B 110b and the virtual disk C of the virtual server C 110c in the virtual disk mapping table 401b. As illustrated in FIG. 8, the master disk column 1002 stores the identifiers of master disks associated with virtual disks which are specified by virtual disk identifiers. Those identifiers are associated with the master disk D 135 created from the basic disk D 133d of the virtual server D 110d.

The logical block number column represents the logical block number of the virtual disk that is specified by an identifier. In this example, the logical block numbers of the virtual disks B, C, D are given by the same method. Specifically, with the number of the top block being “1”, the logical block number increases subsequently by “1”. The sizes of the logical blocks are the same.

A physical block LBA 1004 stores the LBA of a physical block allocated to a logical block. In the physical block LBA 1004, “−1” indicates that the block of the virtual disk that is specified by the identifier is the same as the block of the master disk. A logical block whose number is other than “−1” is not present in the master disk, and is associated with a unique physical block LBA. Those LBAs are the physical block LBAs in the difference disks 134b, 134c.

In access to a common logical block, the address conversion module 402b further refers to the address conversion table (not shown) of the virtual server D to calculate the LBA of the physical block of the master disk. In access to the difference disk 134b, 134c, the address conversion module 402b converts a logical block number acquired from the virtual server 110b, 110c into the physical block LBA registered in the virtual disk mapping table 401b.

Although not illustrated in detail, the virtualization control program 120a of the physical server A 108a and the virtualization control program 120c of the physical server C 108c respectively include the virtual disk mapping tables for the virtual server A 110a and the virtual server D 110d, in the same manner as in the virtualization control program 120b, and refer to the tables to execute conversion processing of the address acquired from the virtual server A 110a and the virtual server D 110d.

<Registration of New Master Disk>

As described above, the computer system according to this embodiment creates a master disk from a basic disk allocated to a virtual server in operation, and further creates a difference disk of another virtual server by referring to the created master disk. Address information on the master disk and the difference disk is stored in the virtual disk mapping table which has been described referring to FIG. 8.

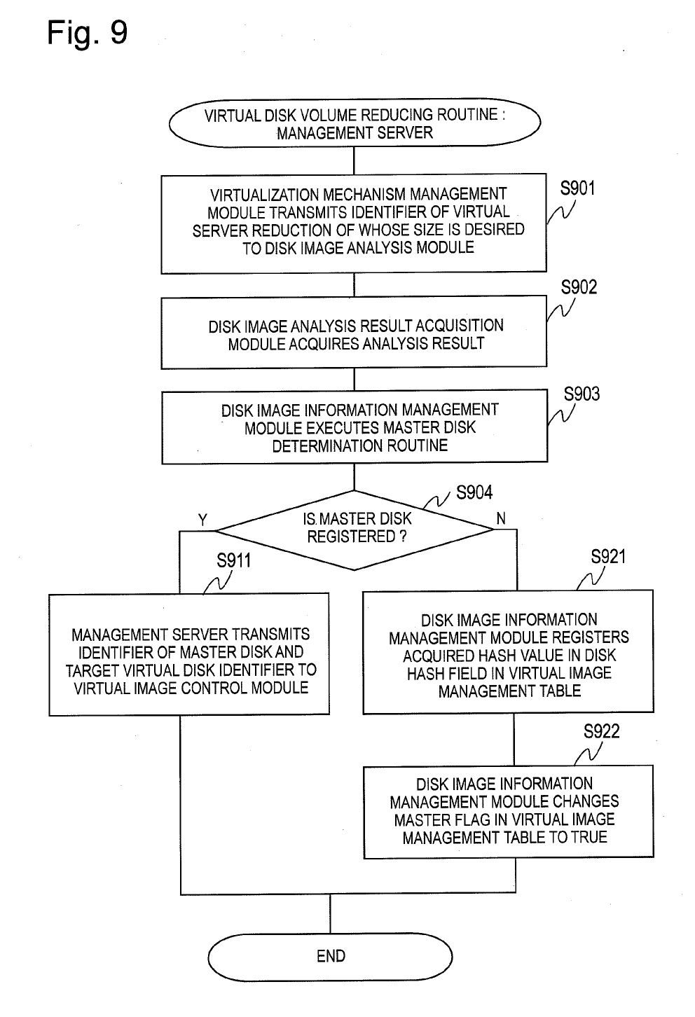

A process of registering information in the virtual image management table 107 is described below referring to a flowchart of FIG. 9. The management server 101 executes this process. Refer to FIG. 3 for the configuration of the management server 101. The master disk is registered in the virtual image management table 107, and a virtual disk size reducing routine in FIG. 9 includes registration of the master disk in the virtual image management table 107. FIG. 10 illustrates an example of the virtual image management table 107. The virtual image management table 107 in FIG. 10 is described in the description of the flowchart of FIG. 9.

As illustrated in FIG. 9, the virtualization mechanism management module 103 in the management server 101 transmits an identifier of the virtual server the reduction of whose actual size is desired to the disk image analysis module of the physical server in which the virtual server is in operation (S901). The routine is described below with the virtual disk D of the virtual server D 110d taken as an example. At the start of this routine, the virtual disk D of the virtual server D 110d is associated with the basic disk 134d.

As illustrated in FIG. 6, in the physical server C 108c, the virtual server D 110d is in operation on the virtualization control program C 120c. The disk image analysis module 124c is in operation on the virtualization control program C 120c. The virtualization mechanism management module 103 transmits the identifier of the virtual server D 110d to the disk image analysis module 124c.

In Step 901, the virtualization mechanism management module 103 refers to the virtual server management table 106 (see FIG. 3). FIG. 11 illustrates one example of the virtual server management table 106. The virtual server management table 106 stores a virtual server identifier 801, a virtual server OS type 802, a virtualization control program identifier 803, a virtual disk identifier 804, a physical server identifier 805, a disk format 806, and a block size 807. A system administrator prepares this table in advance. The virtual server management table 106 associates those pieces of data with one another.

The virtualization mechanism management module 103 executes Step 901 according to a command input by the administrator or a command from the program. The virtualization control program (disk image analysis module) and the physical server at the transmission destination can be specified by the virtual server identifier included in the command. The address of the physical server is stored in the physical server management table 105.

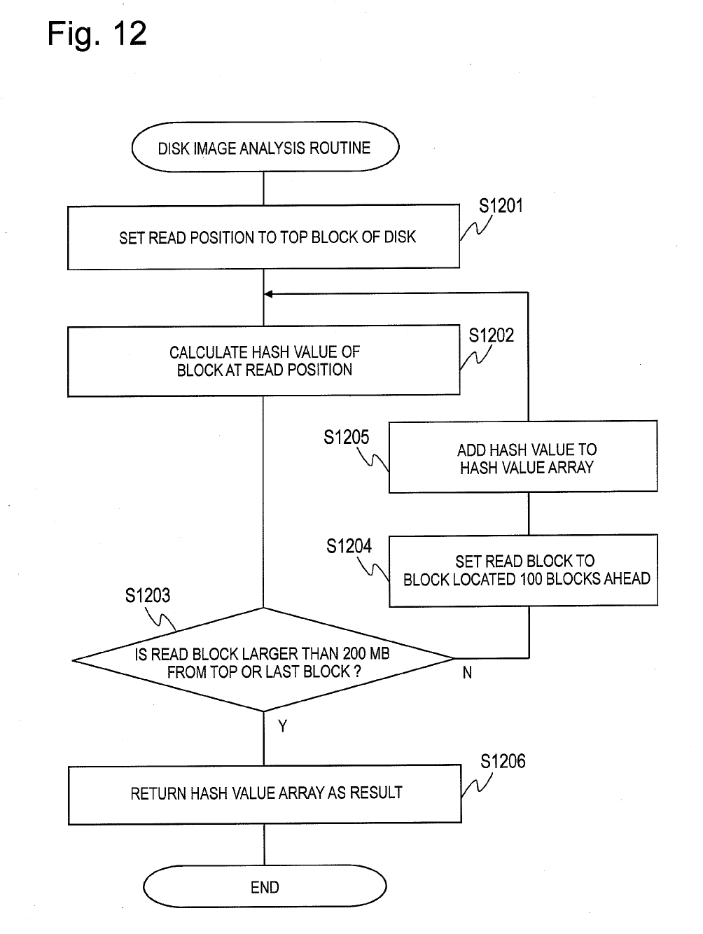

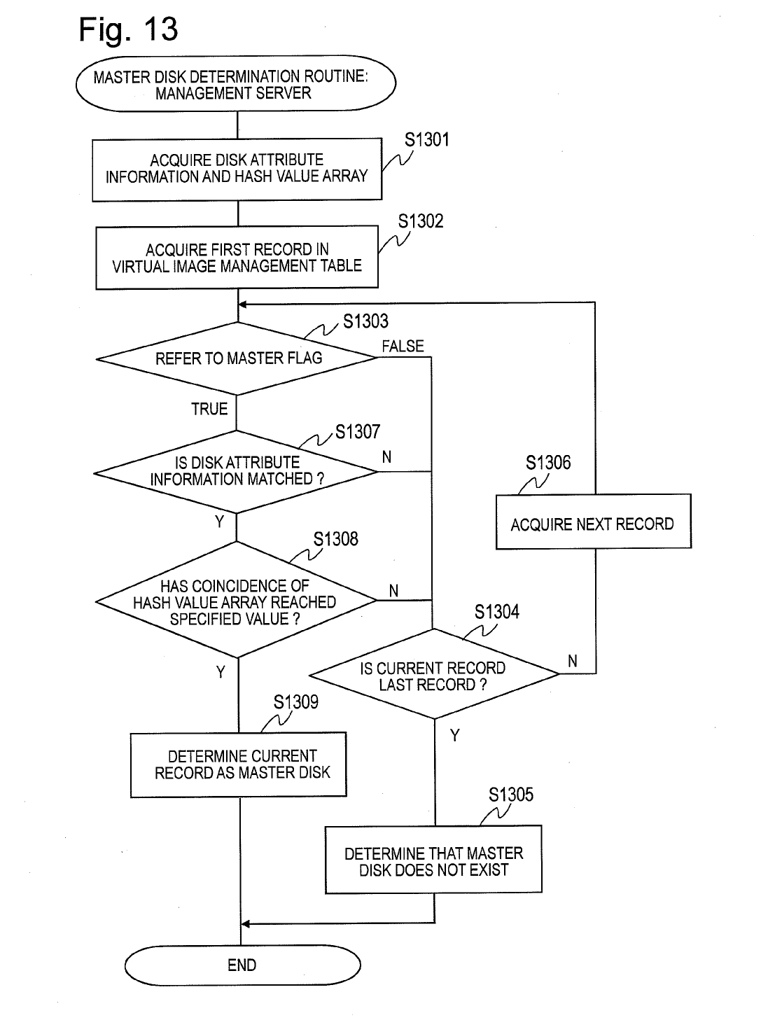

Next, the disk image analysis result acquisition module 211 in the management server 101 acquires an analysis result provided by the disk image analysis module 124c from the virtualization control program 120c (S902). The analysis method of the disk image analysis module 124c is described later referring to FIG. 12. Next, the disk image information management module 210 executes a master disk determination routine (S903). This routine is described later referring to FIG. 13.

When a master disk which satisfies a specified similarity condition with respect to the virtual disk to be subject to size reduction is not registered in the virtual image management table 107 (N in S904), the routine proceeds to Step 921. In this example, the master disk of the virtual disk D does not exist, so that the management server 101 proceeds to Step 921.

When one of the registered master disks satisfies the specified similarity condition with respect to the target virtual disk (Y in S904), the management server 101 transmits the identifiers of the target virtual disk and the master disk to the virtual image control module of the virtualization control program on which the target virtual server is operating (S911). This is to be described later.

In Step 921, the disk image information management module 210 registers a Hash value acquired in Step 903 in the virtual image management table 107. Specifically, the identifier of the virtual disk to be subject to the processing is specified in the column of the virtual disk identifier 804 of the virtual image management table 107, and the Hash value is stored in the field of a disk Hash 905 in that record.

According to this configuration, the analysis result includes a Hash value array containing Hash values of a plurality of blocks as is described later. The field of the disk Hash 905 stores this array (values). In this example, as illustrated in FIG. 10, a Hash value HASH 1 is registered in the record of the virtual disk D.

In the example of the virtual image management table 107 in FIG. 10, information on the virtual disks A to D is stored. A master flag 904 indicates whether the virtual disk is registered as a master disk. The virtual disk of TRUE (only the virtual disk D in this example) is registered as a master disk. A master disk 907 stores master disks for virtual disks. In the example of FIG. 10, the master disks of the virtual disk B and the virtual disk C are the master disks D created from the virtual disk D. The virtual disk A is a basic disk, and is not registered as a master disk, and a corresponding master disk does not exist.

Next, the disk image information management module 210 stores “TRUE” in the field of the master flag 904 in the record of the target virtual disk in the virtual image management table 107 (S922). As illustrated in FIG. 10, in this example, the value of the master flag is set to “TRUE” in the record of the virtual disk D. The value “TRUE” of the master flag indicates that there is a master disk created from (the basic disk of) the virtual disk of that record.

In this manner, the management server 101 compares the master disk registered in the virtual image management table 107 with the specified virtual disk (basic disk), and, when a similar master disk is not registered, registers a master disk created from the basic disk. The master disk may be the basic disk itself, part of the basic disk, or a copy of the basic disk or part thereof.

The virtual disks of all the virtual servers in operation may be subjected to comparison to select a master disk. However, as described above, the master disk of the target virtual server can be determined through efficient processing by selecting the master disk of the target virtual server from the registered master disks.

Because the process of changing a master disk associated with a virtual server has a heavy load, it is preferred that the relation once set be maintained. When a master disk which satisfies a specified similarity condition is not registered, a difference disk is not created as described above, and hence it is possible to avoid inappropriate association from the viewpoint of reducing the size of the whole system and reduce the actual usage amount in the storage device more appropriately.

According to the above-mentioned configuration, when an appropriate master disk is not registered for a target virtual server, (a disk created from) the virtual disk of the virtual server is registered as a master disk. Accordingly, the actual usage amount of another similar basic disk can be reduced afterward. In particular, addition of a virtual server to the system can be appropriately and easily achieved.

<Instruction to Create Difference disk>

In the flowchart of FIG. 9, when the target virtual disk (basic disk) and the master disk satisfy the specified similarity condition (Y in S904), the management server 103 sends the identifiers of the virtual disk and the master disk to the virtual image control module in Step 911. The virtual image control module which has received the identifiers creates a difference disk.

An example of creating the difference disk B 134b of the virtual server B 110b is described below. First, referring to FIG. 9, an example of the process of the management server 101 requesting reduction in the actual usage amount of the virtual disk B is described. A similar process can be performed also for the virtual server C 110c.

The virtualization mechanism management module 103 transmits the identifier of the virtual server B 110b to the disk image analysis module 124b of the physical server 108b (S901). Next, the disk image analysis result acquisition module 211 acquires an analysis result provided by the disk image analysis module 124b from the virtualization control program 120b (S902). The analysis method of the disk image analysis module 124b is described later referring to FIG. 12. Next, the disk image information management module 210 executes the master disk determination routine (S903). This routine is described later referring to FIG. 13.

In this example, the registered master disk D 135 satisfies the condition of the master disk of the virtual disk B (Y in S904). The management server 101 transmits the identifier of the virtual disk B and the identifier of the master disk D 135 to the virtual image control module 123b of the virtualization control program 120b on which the virtual server B 110b is in operation (S911).

<Disk Image Analysis Routine>

The analysis result from the disk image analysis module is used in the comparison of the registered master disk with the virtual disk (basic disk). The process of the disk image analysis module is described below referring to a flowchart of FIG. 12. This process is executed by the disk image analysis module of the virtualization control program that executes the target virtual server for the size reduction request. In the above-mentioned process example for the virtual disk D (example of registration of a master disk), the disk image analysis module 124c executes this process, whereas, in the process example for the virtual disk B (example of creation of a difference disk), the disk image analysis module 124b executes this process.

The example of the processing of the disk image analysis module 124b is described below. The processing of the disk image analysis module 124c is also similar thereto. As illustrated in FIG. 12, the disk image analysis module 124b sets a read position (address) on the target virtual disk to the top logical block (S1201).

Next, the disk image analysis module 124b acquires the physical block address of the basic disk 133b corresponding to the physical block address at the read position from the address conversion module 402b, and reads 100 blocks from the physical block at the read position. The disk image analysis module 124b calculates a Hash value of the read data of 100 blocks (S1202). From the viewpoint of efficient processing, it is preferred that a single Hash value be calculated for 100 blocks. However, a plurality of Hash values may be calculated by a plurality of different types of method.

Next, the disk image analysis module 124b determines whether the amount of data of blocks read so far is larger than 200 MB or whether the last block has been read (S1203). When the amount of data of blocks read so far is equal to or less than 200 MB and the last block has not been read (N in S1203), the disk image analysis module 124b sets the read position to a position 100 logical blocks ahead of the current position (S1204). Further, the disk image analysis module 124b adds a calculated Hash value to the Hash value array (S1205). Thereafter, the disk image analysis module 124b executes Step 1202 again.

In determination in Step 1203, when the amount of data of blocks read is larger than 200 MB or the last block has been read (Y in S1203), the disk image analysis module 124b transmits the Hash value array to the management server 103 (S1206). This Hash value array is the result of analysis on the virtual disk B, which is provided by the disk image analysis module 124b.

Although a Hash value is calculated from data of 100 blocks in the above-mentioned process example, the block size for calculation of a Hash value is set to an appropriate value by design. It is preferred that a Hash value be calculated in the unit of a plurality of blocks. This can ensure efficient and appropriate comparison of similarity. While the disk analysis ends when Hash values are calculated for 200-MB data, the data size is also set to an appropriate value by design. It is preferred that the disk image analysis module calculate Hash values only for partial data in a volume for efficient processing as in this configuration example.

As described above, the disk image analysis module typically calculates a Hash value array for a predetermined number of blocks from the top block. This is because, in general, this region stores an OS and has high commonality to other similar volumes. Depending on the design, Hash value arrays in different regions may be used.

<Master Disk Determination Routine>

As described referring to FIG. 9, the disk image information management module 210 (management server) executes the master disk determination routine (S904) using the analysis result provided by the disk image analysis module (virtualization control program). This routine determines whether a master disk to be the master disk for the target virtual disk is registered in the virtual image management table 107. This routine is described below referring to a flowchart of FIG. 13.

First, the disk image information management module 210 acquires attribute information on the target virtual disk from management information in the virtual server management table 106 in the management server 101. Specifically, the disk attribute information includes the OS type, file format, and block size of the disk. The disk image information management module 210 may acquire the attribute information in the analysis result from the disk image analysis module. Further, the disk image information management module 210 acquires a Hash value array which is the result of analysis on the target disk (see the flowchart of FIG. 12) (S1301).

The target virtual disk is the virtual disk D in the example of the master disk registration, and is the virtual disk B in the example of creating a difference disk. The following describes an example of the determination routine for the virtual disk B. The determination routine for the virtual disk D is similar to the determination routine for the virtual disk B.

The disk image information management module 210 acquires a first record in the virtual image management table 107 (S1302). The disk image information management module 210 determines whether the record is the record of a master disk based on the value of the field of the master flag in the read record (S1303). When the value of the master flag is FALSE, and the record is not the record of a master disk (F in S1303), the disk image information management module 210 determines whether the current record is the last record (S1304).

When the current record is the last record (Y in S1304), the disk image information management module 210 determines that an appropriate master disk for the virtual disk B does not exist (S1305), and terminates the routine. When the current record is not the last record (N in S1304), the disk image information management module 210 reads the next record (S1306), and returns to Step 1303.

When the value of the master flag in the read record is TRUE and the read record is the record of the master disk in Step 1303, the disk image information management module 210 compares the attribute information on the virtual disk B with the disk attribute information in the read record (S1307). When the disk attribute information does not match with each other (at least partially) (N in S1307), the routine proceeds to Step 1304.

When the disk attribute information of the virtual disk B and the disk attribute information of the current record match with each other (Y in S1307), the disk image information management module 210 compares the Hash value arrays of the virtual disk B and the current record (S1308). In this comparison, Hash values at the same positions in the two Hash value arrays are compared in order.

When the coincidence of the Hash value arrays reaches a specific value (Y in S1308), the disk image information management module 210 determines that the master disk of the current record is the master disk for the virtual disk B (S1309). When the coincidence of the Hash value arrays is less than the specific value (N in S1308), the routine proceeds to Step 1304.

As the coincidence, for example, the ratio of the number of pairs of matched Hash values to the total number of pairs of Hash values at the same positions in the two Hash value arrays can be used. For example, when 80% or more of Hash value pairs in the Hash value arrays have matches, it is determined that the coincidence has reached the specific value.

When an appropriate master disk for the virtual disk B is not registered in the virtual image management table 107, the management server 101 registers the virtual disk B as the master disk in the virtual image management table 107 as described above referring to FIG. 9.

In this example, the virtual disk D is registered as an appropriate master disk for the virtual disk B. The master disk D 135 of the virtual disk D satisfies the above-mentioned specific similarity condition for the virtual disk B. In other words, the master disk D 135 has the same disk attribute information, and the coincidence between the Hash value array therefor and the Hash value array for the virtual disk B reaches a specific value.

In this configuration example, the disk image information management module 210 sequentially compares Hash values in the Hash value arrays for the virtual disk B with Hash values in the Hash value arrays for the master disk. When the number of matched Hash values reaches the specific value, the disk image information management module 210 determines that the coincidence thereof satisfies the reference. The number of matched Hash values to be the condition is set to an appropriate value by design.

The comparison of the Hash value arrays takes a comparative processing time. When the disk attribute information of the target virtual disk and that of the master disk are compared with each other, and the disk attribute information do not match with each other, it is determined that the master disk is not appropriate without comparing the Hash value arrays. Thus, the master disk determination routine can be executed efficiently.

The disk attribute information for comparison and determination includes appropriate information by design. It is preferred, similarly to this configuration, that the disk attribute information include the OS type, the file format, and the block size. It is particularly preferred that the disk attribute information include the OS type and the file format. This is because disks different in those pieces of information have low similarity in most cases.

In the above-mentioned configuration, a Hash value is calculated from a specific number of blocks. Therefore, the size of data from which a Hash value is calculated differs between disks with different block sizes. Depending on the design, the disk analysis module may calculate a Hash value from data with a common size with respect to disks with different block sizes.

In the example illustrated in FIG. 11, for example, the disk analysis module calculates a Hash value for every 50 data blocks for the virtual disk B, and calculates a Hash value for every 100 data blocks for the virtual disk A. In this configuration, the block size may be eliminated from the disk attribute information for comparison and determination.

In the above-mentioned configuration example, the target virtual disk is sequentially compared with master disks, and when a master disk to be compared satisfies a condition, this master disk is determined as the master disk for the target virtual disk. Unlike this scheme, the disk image information management module 210 may compare all the registered master disks with the target virtual disk. Of the master disks which satisfy the condition for selecting a master disk, the master disk with the highest coincidence in Hash value array is selected as the master disk for the target virtual disk.

<Difference disk Creation Routine>

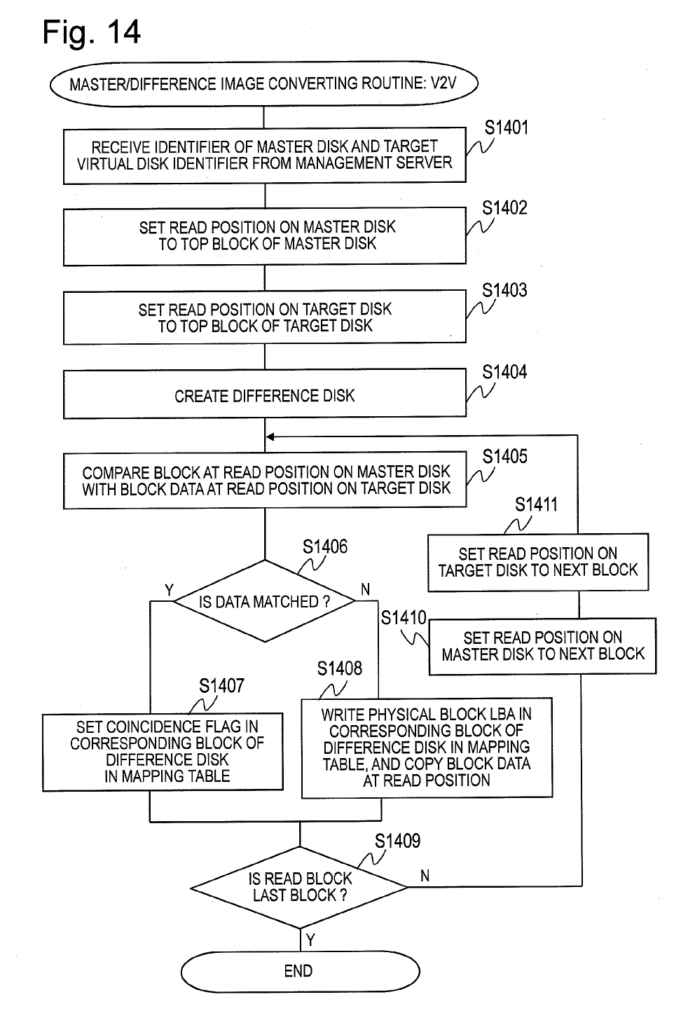

The routine that has been described referring to FIG. 13 determines a master disk for a target virtual disk. Next, a routine for creating a difference disk from the determined master disk and the target virtual disk (basic disk) is described. A flowchart illustrated in FIG. 14 represents the flowchart for this routine. The virtualization control program of the target virtual server executes this routine. In the following, this routine is described with the virtualization control program 120b of the virtual server B 110b taken as an example.

As illustrated in FIG. 14, a master/difference image conversion module 403b (see FIG. 5A) of the virtualization control program 120b receives the identifier of the master disk, namely, the identifier indicating the master disk D 135 of the virtual disk D in this example, and the identifier of the target virtual disk B (basic disk) from the management server 101 (S1401).

Next, the master/difference image conversion module 403b sets the read position on the master disk to the top block of the master disk (S1402). Further, the master/difference image conversion module 403b sets the read position on the virtual disk B to the top block of the virtual disk B (S1403). Next, the master/difference image conversion module 403b creates a difference disk B of the virtual disk B (S1404). This difference disk B is a disk region where data has not been stored yet.

Next, the master/difference image conversion module 403b compares a block at the read position on the master disk with a block at the read position on the virtual disk B (S1405). When data of the two blocks match with each other (Y in S1406), the master/difference image conversion module 403b sets a coincidence flag “−1” to the record of that block of the difference disk B in the virtual disk mapping table 401b (S1407).

When data of the two blocks do not match with each other (N in S1406), the master/difference image conversion module 403b sets the LBA of the physical block in the virtual disk mapping table 401b. Further, the master/difference image conversion module 403b copies a block (data) at the read position on the basic disk B to the LBA (S1408).

When the read block is the last block (Y in S1409), this routine is terminated. When the read block is not the last block (N in S1409), the master/difference image conversion module 403b sets the read position on the master disk D 135 to the next block (S1410), and further sets the read position on the target disk D to the next block (S1411). Then, the routine returns to Step S1405.

With this routine, data blocks at the same address are sequentially acquired from the master disk and the target basic disk and are compared with each other, so that the data block in the basic disk, which is common to (has the same content as) the corresponding data block in the master disk, and the data block in the basic disk, which differs from the corresponding data block in the master disk, can be specified.

According to this routine, a difference disk that stores difference data containing data blocks different from those in the master disk is created in the target basic disk, and then address conversion data for access by the virtual server thereafter is stored in the virtual disk mapping table. Accordingly, the virtual server can access the difference disk and the master disk with the same address as used before. Refer to FIGS. 7 and 8 and the descriptions thereof for the virtual disk mapping table and address conversion thereby.

In the above-mentioned routine, block data on the master disk itself is compared with block data on the target disk. This can surely determine coincidence/non-coincidence of the block data. Depending on the design, the master/difference image conversion module 403b may determine coincidence/non-coincidence of the block data using Hash values of the block data. The master/difference image conversion module 403b calculates Hash values from acquired blocks, and compares the Hash values with each other. When the Hash values match with each other, it is determined that two pieces of block data are identical.

To avoid different pieces of block data from being determined as identical, it is preferred that a plurality of Hash values be calculated from each block data. Hash values of different types are calculated using different calculation methods. Because higher accuracy on determining coincidence of block data is demanded as compared with accuracy in comparison of similarity between disks, it is preferred that the number of types of Hash values be larger than the number of types of Hash values in determination on similarity. From the viewpoint of efficient processing and accurate determination, it is preferred that only a single Hash value be used in similarity determination, and two types of Hash values be compared with each other in specifying a storage block on the difference disk.

The above-mentioned routine copies data to be stored in a difference disk from a basic disk, and stores the data in a region in the basic disk different from a physical region. Depending on the design, the region of a difference disk may include the region of a basic disk, and blocks of difference data may stay in the same region in the basic disk. When the block sizes of two volumes differ from each other, block data with a large size may be compared with a plurality of pieces of block data with small sizes.

<Transition from Physical Server to Virtual Server>

The following describes a process of transition of the environment of a physical server to a virtual environment (P2V). Specifically, according to this embodiment, when there is an appropriate master disk at the time of transition of data (volume) in a physical server to a virtual environment, the volume to be migrated is compared with the master disk to create a new difference disk. This can eliminate the process of creating a difference disk after transition to the virtual environment. Further, according to this embodiment, only data to be stored in the difference disk is migrated to a new physical server as a preferred method. In this way, the transition process to the virtual environment can be performed efficiently.

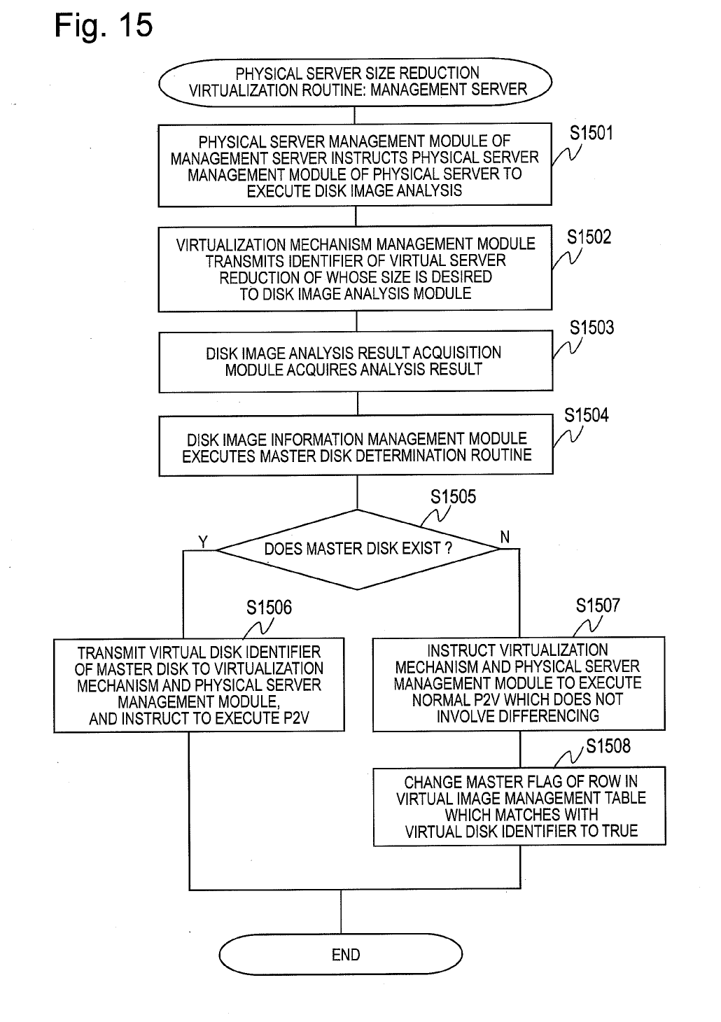

This process includes processes of determining whether a master disk is present, creating a difference disk, and storing data in the difference disk. Referring to FIG. 15, a description is given on a process of determining a master disk. The process of FIG. 15 corresponds to the process of FIG. 9. In the following, a description is given on, as an example, a process of migrating data of a volume in the physical server D to a volume of the physical server B.

First, the physical server management module 102 in the management server 101 instructs the physical server management module 126 in the physical server 108d (see FIG. 4) to execute disk image analysis (S1501). In response to the instruction from the physical server management module 126, the disk image analysis module 122 in the physical server 108d executes disk image analysis. The method of analysis is the same as the one described referring to FIG. 12. The physical server management module 126 sends this analysis result to the management server 101 (S1502). The disk image analysis acquisition module 211 in the management server 101 acquires the analysis result (S1503).

The disk image information management module 210 in the management server 101 executes the master disk determination routine (S1504). This routine is the same as the processes in the flowchart of FIG. 13. When there is an appropriate master disk (Y in S1505), the management server 101 sends the identifier of the master disk and an instruction for the transition process to the physical server management module 126 in the physical server 108d and the virtualization control program 120b at the transition destination (S1506).

When there is no appropriate master disk (N in S1505), an instruction for the usual transition process in which a difference disk is not created (differencing is not performed) is sent to the physical server management module 126 in the physical server 108d and the virtualization control program 120b at the transition destination (S1507). Further, the disk image information management module 210 registers a recording including the identifier of a new virtual disk in the virtual image management table 107. In this record, the master flag is set to “TRUE” (S1508).

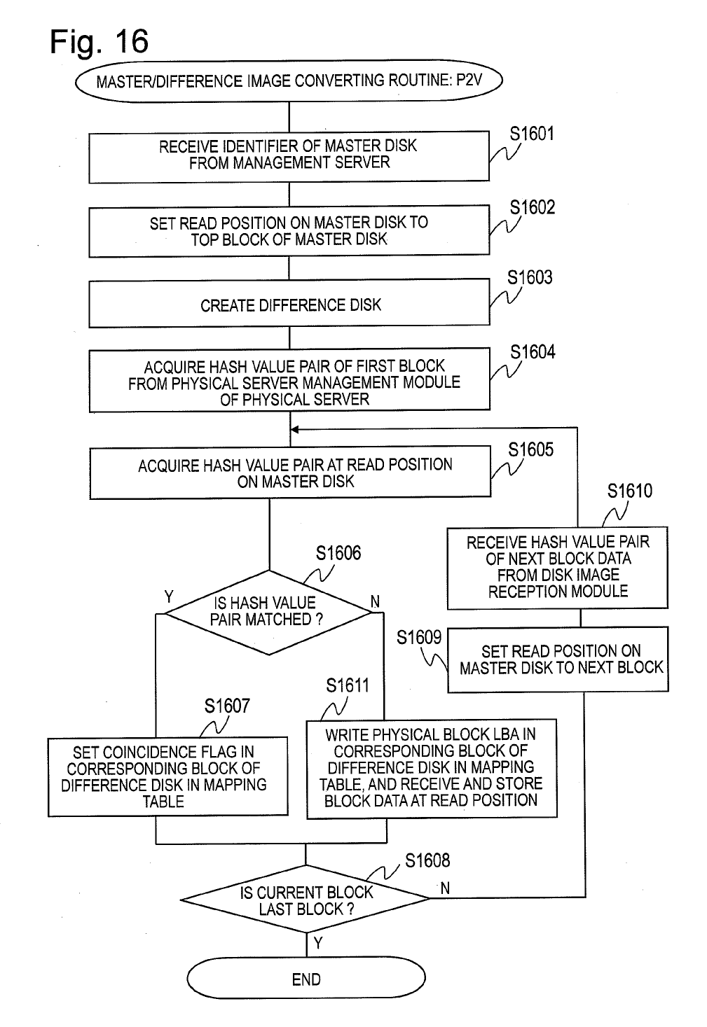

Next, a process including creation of a difference disk is described referring to a flowchart of FIG. 16. The master/difference image conversion module 403b in the physical server B 108b acquires the identifier of the master disk from the management server 101 (S1601). Next, the master/difference image conversion module 403b sets the read position on the master disk to the top block (S1602). Next, the master/difference image conversion module 403b creates a difference disk (S1603).

Next, the master/difference image conversion module 403b acquires two Hash values for the first block from the physical server management module 126 in the physical server 108d (S1604). The Hash values are calculated by the disk image analysis module 122. The disk image analysis module 122 calculates two Hash values using two different calculation methods.

The master/difference image conversion module 403b acquires two Hash values (Hash value pair) in the block at the read position on the master disk (S1605). The Hash values are calculated by the disk image analysis module 124b. The calculation methods are the same as those used by the disk image analysis module 122. If Hash values are registered in the Hash value array in the table, the values may be used.

The master/difference image conversion module 403b compares the Hash value pairs for two pieces of block data (S1606). When the Hash value pairs are identical (Y in S1606), that is, when the Hash values provided by each of different calculation methods are identical, the master/difference image conversion module 403b determines that the two blocks of data match with each other. When the two Hash values of one of the different calculation methods do not match with each other (N in S1606), the master/difference image conversion module 403b determines that the two blocks of data do not match with each other.

When the Hash value pairs for two blocks of data match with each other (Y in S1606), the master/difference image conversion module 403b sets the coincidence flag “−1” to the field of the physical block LBA of the record of that block in the mapping table (S1607). The master/difference image conversion module 403b determines whether the current block is the last block (S1608). When the current block is the last block (Y in S1608), the master/difference image conversion module 403b terminates the process.

When the current block is not the last block (N in S1608), the master/difference image conversion module 403b sets the read position on the master disk to the next block (S1609), and then acquires a Hash value pair of the next block data from the physical server D 108d (S1610). Thereafter, the master/difference image conversion module 403b executes the steps after Step 1605.

When the two blocks of data do not match with each other in Step 1606 (N in S1606), the master/difference image conversion module 403b instructs a disk image reception module 125a to receive block data.

The virtual disk reception module 125a sends an instruction to the disk image transmission module in the physical server 108d to receive the corresponding block data from the disk image transmission module. The master/difference image conversion module 403b writes the physical block LBA of that block data in the virtual server mapping table 401b, and further writes the received block data at the address on the difference disk (S1611). The process then proceeds to Step 1608.

In the transition from a physical environment to a virtual environment, this process creates a difference disk, and stores difference data between the master disk and the target disk therein. Therefore, the actual storage size after transition can be reduced. Further, block data in volume data, which is different from that on the master disk, is selectively migrated as a preferred method, thus ensuring an efficient transition process. Depending on the design, the master/difference image conversion module may sequentially acquire block data from the volume at the transitional origin, and compare the block data with block data in the same block on the master disk.

The above-mentioned process uses two Hash values in comparison of block data. For more accurate comparison of block data, it is preferred that a plurality of types of Hash values be used. The number of calculation methods for Hash values to be used is selected to be an appropriate value depending on the design. Depending on the design, identity may be determined with only a single Hash value.

Determination on coincidence of block data in storing data on a difference disk requires higher accuracy than determination on coincidence of data in determination of similarity between disks. Therefore, it is preferred that the number of types of Hash values be larger than the number of types of Hash values in determination of similarity. From the viewpoint of the efficient processing and accurate determination, it is preferred that only a single Hash value be used in determination of similarity, and two types of Hash values be compared with each other in specifying a block to be stored on a difference disk.

Although the detailed description of this invention has been given referring to the accompanying drawings, this invention is not limited to such specific configurations, and shall encompass various modifications and equivalent configurations within the scope of the appended claims. For example, part of a program may be realized by dedicated hardware. A program may be installed on each computer via a program distributing server and a non-transitory computer readable storage medium, so that the program can be stored in a storage device including a non-transitory storage medium in each computer.

While it is preferred that the above-mentioned individual modules execute the respective processes according to this embodiment, the management server may execute part of the processes that a physical server executes, or alternatively, part of the processes that the management server executes may be installed on the management server. Although it is preferred that a master volume be created from the volume of a virtual server in operation according to this embodiment, a difference volume may be created from the volume of a virtual server in operation by referring to a master volume prepared separately from the virtual server in operation.

As described above, a master disk and a basic disk from which a difference disk is created may be allocated to the same physical server or may be allocated to different physical servers. The storage device can include a single storage sub system or a plurality of storage sub systems. Although the storage device stores data on a disk device in the above-mentioned configuration examples, the storage device can store data on a data storage medium different from a disk device.

This invention can be used in a computer system that includes a physical server which executes a virtual server and a storage device which provides the virtual server with a volume.

1. A computer system, comprising:
a management apparatus;
a storage apparatus; and
a physical server, wherein:
the management apparatus registers a master volume created from a first volume provided by the storage apparatus to a first virtual server in operation;
the storage apparatus creates, when a second volume provided by the storage apparatus to a second virtual server operating on the physical server satisfies a specific similarity condition with respect to the registered master volume, a difference volume for storing difference data between the master volume and a volume of the second virtual server; and
the second virtual server accesses the difference volume and the master volume.

2. The computer system according to claim 1, wherein the registration of the master volume created from the first volume is on a condition that no master volume which satisfies the specific similarity condition with respect to the first volume is registered.

3. The computer system according to claim 2, wherein the storage apparatus creates a difference volume for the first virtual server, and writes update data on the first virtual server after the creation of the master volume in the difference volume for the first virtual server.

4. The computer system according to claim 2, wherein:
the specific similarity condition includes that a quantity of matched Hash values between a Hash value array of the second volume and a Hash value array of the master volume reaches a specific value; and
each of the Hash values of the Hash value array of the second volume is calculated from data of a specific size, which is formed of at least one block data, and each of the Hash values of the Hash value array of the master volume is calculated from data of the specific size, which is formed of at least one block data.

5. The computer system according to claim 4, wherein in determination of the specific similarity condition, the management apparatus makes determination on the Hash value array when specific attribute information of the first volume matches with specific attribute information of the master volume.

6. The computer system according to claim 5, wherein:
the master volume is the first volume; and
the storage apparatus creates a difference volume for the first virtual server, and writes update data on the first virtual server after the creation of the master volume in the difference volume in response to an instruction from the first virtual server.

7. The computer system according to claim 1, wherein when, in transition of a server program including an OS to the physical server on which a virtualization control program for the second virtual server is running from another physical server, a third volume allocated to the server program satisfies the specific similarity condition with respect to the registered master volume:
the physical server creates a second difference volume for storing difference data between the master volume and the third volume in the storage apparatus; and
the another physical server selectively transmits the difference data to be stored in the second difference volume to the physical server from the third volume.

8. The computer system according to claim 7, wherein:
determination of the specific similarity condition uses Hash values calculated from data in the third volume and the master volume;
the difference data is specified by using the Hash values of the third volume and the master volume; and
a number of Hash values to be calculated from a piece of data in the specification of the difference data is larger than a number of Hash values to be calculated from a piece of data in the determination of the specific similarity condition.

9. A method of allocating a volume to a virtual server in a computer system including a physical server which executes the virtual server, and a storage apparatus which provides the physical server with a volume, the method comprising:
executing, by the physical server, a virtualization control program and the virtual server which operates on the virtualization control program to access the volume of the storage apparatus;
creating, by the storage apparatus, a difference volume;
storing, by the physical server, difference data between a master volume and the volume of the virtual server which is currently executed in the difference volume; and
accessing, by the virtual server, to the difference volume and the master volume.

10. The method according to claim 9, wherein:
the master volume is created from a second volume provided to a second virtual server in operation by the storage apparatus, and is registered in a table; and
the difference volume is created when the volume and the master volume satisfy a specific similarity condition.

11. The method according to claim 10, wherein the registration of the master volume created in the table is on a condition that no master volume which satisfies the specific similarity condition with respect to the first volume is registered.

12. A non-transitory computer-readable storage medium having stored thereon a program for controlling a system to execute a process, the system including a management apparatus, a physical server that executes a virtualization control program and a virtual server which operates on the virtualization control program, and a storage apparatus which provides the virtual server with a volume, the process comprising:
registering, by the management apparatus, a master volume created from a first volume provided to a first virtual server in operation by the storage apparatus in a table;
determining, by the management apparatus, a specific similarity condition between a second volume provided to a second virtual server by the storage apparatus and the master volume registered in the table; and
determining, by the management apparatus, when the specific similarity condition is satisfied, to create a difference volume which stores difference data between the master volume and a volume of the second virtual server, and which is accessed, together with the master volume, by the virtual server.

13. The non-transitory computer-readable storage medium according to claim 12, wherein the registration of the master volume created from the first volume is on a condition that no master volume which satisfies the specific similarity condition with respect to the first volume is registered.
